(19) United States
(12) Patent Application Publication
(10) Pub. No.: US 2020/0316420 A1
(43) Pub. Date: Oct. 8, 2020

(54) AIR ASPIRATING FITTINGS

(71) Applicant: Tyco Fire Products LP, Lansdale, PA (US)

(72) Inventors: John Dewey Morrison, Porterfield, WI (US); Donald M. Bjorkman, Menominee, MI (US)

(21) Appl. No.: 16/839,266

(22) Filed: Apr. 3, 2020

Related U.S. Application Data
(60) Provisional application No. 62/829,936, filed on Apr. 5, 2019.

(51) Int. Cl. A62C 35/68; A62C 35/60

(52) U.S. Cl. CPC A62C 35/68; A62C 35/60

(57) ABSTRACT

A connector for a fire suppression system includes a body, an inlet, an outlet, an inner volume, a venturi portion, and an air inlet. The inlet includes an inlet aperture configured to receive a fire suppressant agent. The outlet includes an outlet aperture configured to output aspirated fire suppressant agent. The inner volume of the body defines a fluid flow path between the inlet and the outlet. The venturi portion is positioned along the fluid flow path of the inner volume and is configured to produce a low pressure region within the inner volume of the body. The air inlet is configured to provide air to the low pressure region.

### CROSS-REFERENCE TO RELATED PATENT APPLICATION

This application claims the benefit of and priority to U.S. Provisional Patent Application No. 62/829,936, filed Apr. 5, 2019, the entire disclosure of which is incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant agent throughout the area. The fire suppressant agent then extinguishes or prevents the growth of the fire. Various sprinklers, nozzles, and dispersion devices are used to disperse the fire suppressant agent throughout the area.

### SUMMARY

One implementation of the present disclosure is a connector for a fire suppression system. In some embodiments, the connector includes a body, an inlet, an outlet, an inner volume, a venturi portion, and an air inlet. In some embodiments, the inlet includes an inlet aperture configured to receive a fire suppressant agent. In some embodiments, the outlet includes an outlet aperture configured to output aspirated fire suppressant agent. In some embodiments, the inner volume of the body defines a fluid flow path between the inlet and the outlet. In some embodiments, the venturi portion is positioned along the fluid flow path of the inner volume and is configured to produce a low pressure region within the inner volume of the body. In some embodiments, the air inlet is configured to provide air to the low pressure region.

In some embodiments, the connector is a nipple connector, an elbow connector, or a T-connector.

In some embodiments, the inlet aperture is configured to fluidly couple with a first pipe configured to provide the fire suppressant agent to the inlet. In some embodiments, the outlet aperture is configured to fluidly couple with a second pipe to discharge aspirated fire suppressant agent.

In some embodiments, the connector is configured to aerate, aspirate, or expand the fire suppressant agent and is configured for a wet pipe fire suppression system or a dry pipe fire suppression system.

In some embodiments, the air inlet is configured to provide the air to the low pressure region at a position downstream of the venturi portion.

In some embodiments, the air inlet is configured to sealingly couple with a one-way valve to allow a flow of air into the inner volume of the connector and restrict a flow of the fire suppressant agent out of the inner volume of the connector.

In some embodiments, the air inlet is configured to provide air into the inner volume in a direction substantially perpendicular to a flow of the fire suppressant agent.

In some embodiments, the fire suppressant agent is or includes non-fluorinated foam.

In some embodiments, the venturi portion includes a converging portion and an orifice positioned downstream of the converging portion.

Another implementation of the present disclosure is a fire suppression system configured to provide a fire suppressant agent to an area for fire suppression. In some embodiments, the system includes a delivery system, and a piping system fluidly coupled to the delivery system. In some embodiments, the delivery system is configured to move the fire suppressant agent through the piping system. In some embodiments, the piping system includes a connector configured to aspirate the fire suppressant agent. In some embodiments, the connector includes a body, an inlet, an outlet, an inner volume, a venturi portion, and an air inlet. In some embodiments, the inlet includes an inlet aperture configured to receive the fire suppressant agent. In some embodiments, the outlet includes an outlet aperture configured to output aspirated fire suppressant agent. In some embodiments, the inner volume of the body defines a fluid flow path between the inlet and the outlet. In some embodiments, the venturi portion is positioned along the fluid flow path of the inner volume and configured to produce a low pressure region within the inner volume of the body. In some embodiments, the air inlet is configured to provide air to the low pressure region.

In some embodiments, the fire suppressant agent is a foam fire suppressant agent.

In some embodiments, the connector is a nipple connector, an elbow connector, or a T-connector.

In some embodiments, the inlet aperture is configured to fluidly couple with a first pipe of the piping system to provide the fire suppressant agent to the inlet and the outlet aperture is configured to fluidly couple with a second pipe of the piping system to discharge aspirated fire suppressant agent.

In some embodiments, the connector is configured to aerate, aspirate, or expand the fire suppressant agent and is configured for a wet pipe fire suppression system or a dry pipe fire suppression system.

In some embodiments, the air inlet is configured to provide the air to the low pressure region at a position downstream of the venturi.

In some embodiments, the air inlet is configured to sealingly couple with a one-way valve to allow flow of air into the inner volume of the connector and restrict flow of the fire suppressant agent out of the inner volume of the connector.

In some embodiments, the air inlet is configured to provide air into the inner volume in a direction substantially perpendicular to a flow of the fire suppressant agent.

Another implementation of the present disclosure is a method for suppressing a fire. In some embodiments, the method includes providing a fire suppression system having a tank configured to store a fire suppressant agent, a piping system fluidly coupled with the tank, a connector, and a discharge device fluidly coupled to the piping system downstream of the connector. In some embodiments, the method includes driving the fire suppressant agent through the piping system and the connector to the discharge device. In some embodiments, the connector includes multiple inner passageways configured to receive the fire suppressant agent at a first end, draw air into the fire suppressant agent at a low pressure region to aspirate the fire suppressant agent, and discharge the fire suppressant agent at a second end.

In some embodiments, the connector is any of a nipple connector, an elbow connector, or a T-connector. In some embodiments, the connector is configured to aspirate the fire suppressant agent before the fire suppressant agent is provided through the piping system to the discharge device.

In some embodiments, the connector includes a venturi portion configured to produce the low pressure region. In some embodiments, the air inlet is fluidly coupled with atmospheric air and the low pressure region. In some embodiments, a flow of the fire suppressant agent through the connector draws air into the connector through the air inlet to aspirate the fire suppressant agent.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic of a fire suppression system including multiple sprinklers which distribute a fire suppressant agent over an area, according to an exemplary embodiment;

FIG. 2 is a sectional view of a nipple connector configured to receive a fire suppressant agent, aerate/aspirate the fire suppressant agent, and output the aerated/aspirated fire suppressant agent, according to an exemplary embodiment;

FIG. 3 is a sectional view of an elbow connector configured to receive a fire suppressant agent, aerate/aspirate the fire suppressant agent, and output the aerated/aspirated fire suppressant agent, according to an exemplary embodiment;

FIG. 4 is a sectional view of a T-connector configured to receive a fire suppressant agent, aerate/aspirate the fire suppressant agent, and output the aerated/aspirated fire suppressant agent, according to an exemplary embodiment;

FIG. 5 is a sectional view of a check valve which may be used with any of the connectors of FIGS. 2-4, according to an exemplary embodiment;

FIG. 6 is a bottom view of the check valve of FIG. 5, according to an exemplary embodiment;

FIG. 7 is a bottom view of the T-connector of FIG. 4, having an air inlet in a first orientation, according to an exemplary embodiment;

FIG. 8 is a bottom view of the T-connector of FIG. 4, having an air inlet in a second orientation, according to an exemplary embodiment;

FIG. 9 is a sectional view of the nipple connector of FIG. 2, showing the fluid flow path formed by the inner volume of the nipple connector, according to an exemplary embodiment;

FIG. 10 is a sectional view of the elbow connector of FIG. 3, showing the fluid flow path formed by the inner volume of the elbow connector, according to an exemplary embodiment;

FIG. 11 is a sectional view of the T-connector of FIG. 4, showing the fluid flow path formed by the inner volume of the T-connector, according to an exemplary embodiment;

FIG. 12 is a sectional view of a venturi including a linearly decreasing portion, a straight portion, and a linearly increasing portion of any of the nipple connector, the elbow connector, or the T-connector of FIGS. 2, 3, and 4, according to an exemplary embodiment;

FIG. 13 is a sectional view of a venturi including a linearly decreasing portion, a straight portion, a linearly increasing portion, and an orifice, of any of the nipple connector, the elbow connector, or the T-connector of FIGS. 2, 3, and 4, according to an exemplary embodiment;

FIG. 14 is a sectional view of a venturi including a linearly decreasing portion and a straight portion of any of the nipple connector, the elbow connector, or the T-connector of FIGS. 2, 3, and 4, according to an exemplary embodiment;

FIG. 15 is a sectional view of a venturi including a linearly decreasing portion of any of the nipple connector, the elbow connector, or the T-connector of FIGS. 2, 3, and 4, according to an exemplary embodiment;

FIG. 16 is a sectional view of a venturi including a linearly decreasing portion, a linearly increasing portion, and an orifice, of any of the nipple connector, the elbow connector, or the T-connector of FIGS. 2, 3, and 4, according to an exemplary embodiment;

FIG. 17 is a sectional view of a venturi including a linearly decreasing portion and an orifice of any of the nipple connector, the elbow connector, or the T-connector of FIGS. 2, 3, and 4, according to an exemplary embodiment;

FIG. 18 is a sectional view of a venturi including a non-linearly decreasing portion, a straight portion, and a non-linearly increasing portion, of any of the nipple connector, the elbow connector, or the T-connector of FIGS. 2, 3, and 4, according to an exemplary embodiment; and

FIG. 19 is a sectional view of a venturi including a non-linearly decreasing portion, a straight portion, and an orifice, of any of the nipple connector, the elbow connector, or the T-connector of FIGS. 2, 3, and 4, according to an exemplary embodiment.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, various embodiments of a connector are disclosed. A nipple connector, an elbow connector, and a T-connector are shown and described. Each of these connectors are configured to receive a fire suppressant agent via an inlet aperture, and introduce air to aspirate the fire suppressant agent. Each connector may include one or more outlet apertures configured to provide the aspirated fire suppressant agent to a pipe. The pipe may be fluidly coupled with a sprinkler. The connectors can use a venturi portion to produce a low pressure region. The air may be drawn into the mixing chamber at the low pressure region downstream of the venturi to facilitate aspiration/aeration of the fire suppressant agent therewithin. Other types of connectors may be used according to various alternative embodiments.

### Fire Suppression System

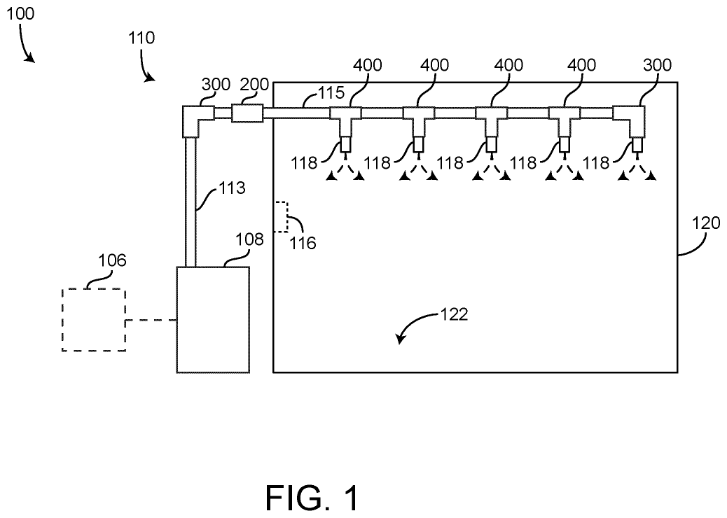

Referring to FIG. 1, a fire suppression system 100 is shown, according to an exemplary embodiment. Fire suppression system 100 includes a delivery system 108 configured to provide the fire suppressant agent to sprinklers 118. Delivery system 108 may include a tank, a container, a reservoir, a capsule, a cartridge, etc., configured to store fire suppressant agent within an inner volume. Delivery system 108 can include a prime mover (e.g., a pump, a compressor, a fan, a motor, etc.). The prime mover can be fluidly coupled with the reservoir that contains the fire suppressant agent via a pipe, hose, tube, tubular member, etc. The prime mover can drive the fire suppressant agent and provide the fire suppressant agent to sprinklers 118. In other embodiments, delivery system 108 includes, but is not limited to, bladder tanks, premix tanks, municipal water supply, etc. For example, delivery system 108 may include a tank having a compressed gas configured to drive the fire suppressant agent to sprinklers 118. Delivery system 108 may use any of or a combination of a compressed gas, municipal water, a bladder tank, a prime mover, etc., to provide the fire suppressant agent to sprinklers 118. The fire suppressant agent may be water, an expandable foam, a non-fluorinated foam, a fluorinated foam, etc., or any other agent that can be used to suppress a fire. Delivery system 108 can be any form of delivery system (e.g., a bladder tank system, a pump system, a pre-mix system, etc.) configured to provide the fire suppressant agent to sprinklers 118.

Fire suppression system 100 is configured to suppress a fire at area 122 within space 120. Space 120 may be a room of a building, an oven, a vehicle, a duct, etc., or any other device, system, area, or space at which a fire may occur. In an exemplary embodiment, space 120 is a room of a building.

Delivery system 108 is configured to provide the fire suppressant agent to piping system 110. Piping system 110 may include any plumbing components such as T-connectors 400, pipes 113/115, tubes, elbow connectors 300, nipple connectors 200, etc. Piping system 110 includes pipe 115 which extends through space 120 or above area 122 for which fire suppression is desired. Pipe 115 is fluidly coupled with multiple sprinklers, nozzles, dispersion devices, etc., shown as sprinklers 118. Sprinklers 118 are configured to receive the fire suppressant agent from pipe 115 and deliver (e.g., sprinkle, diffuse, spread, spray, etc.) the fire suppressant agent to area 122 and space 120. Sprinklers 118 may be pendant sprinklers configured to hang above area 122. In other embodiments, sprinklers 118 are upright sprinklers configured to protrude upwards from area 122.

Delivery system 108 may be controlled by controller 106 in some embodiments. Controller 106 is optional and may be used to control delivery system 108 depending on the type of delivery system 108 used and/or the type of fire suppression system 100. Controller 106 may include a processing circuit having a processor and memory. Controller 106 may be configured to receive input information from a sensor 116 to determine if fire suppression system 100 should be activated. Sensor 116 is also optional and may be used by controller 106, depending on the type of delivery system 108 and/or the type of fire suppression system 100. If fire suppression system 100 includes controller 106, controller 106 can use a fire detection algorithm to process any received sensory information. Sensor 116 may be or include one or more sensors. The sensors may be configured to measure values of various variables which are associated with and relevant to fire detection. For example, sensor 116 may be or include any of one or more temperature sensors, pressure sensors, light sensors, fire alarms, etc. Sensors 116 may be configured to measure various conditions within space 120 or within piping system 110. Delivery system 108 may be configured to increase a pressure of piping system 110 such that fire suppressant agent is provided to sprinklers 118.

Fire suppression system 100 may be either a wet sprinkler system or a dry sprinkler system. For example, if fire suppression system 100 is a wet sprinkler system, piping system 110 contains a liquid (e.g., the fire suppressant agent) therewithin before sprinklers 118 are actuated to an open position for fire suppression. Wet sprinkler systems are often used when space 120 and/or piping system 110 are not exposed to low temperatures and are therefore not at a risk of freezing. If fire suppression system 100 is a dry sprinkler system, all or a portion of piping system 110 (or any pipes downstream of delivery system 108) do not include the fire suppressant agent or liquid until it is determined that fire suppression system 100 should be activated. If fire suppression system 100 is a dry sprinkler system, air or a gas is present in piping system 110 downstream of delivery system 108. When a pressure of the air or gas changes such that it is below a threshold value (e.g., due to one of sprinklers 118 activating), delivery system 108 activates to provide piping system 110 and sprinklers 118 with the fire suppressant agent. The fire suppressant agent of fire suppression system 100 may be a liquid, a gas, a foam, etc. For example, the fire suppressant agent may be water. In other embodiments, the fire suppressant agent is a non-fluorinated foam. If fire suppression system 100 is configured to deliver a foam, one or more components of fire suppression system 100 may be configured to aerate the foam. For example, any of the connectors (e.g., elbow connector 114) may be configured to aerate the foam before it is provided to sprinklers 118. Likewise, sprinklers 118 may be configured to aerate the foam before the aerated foam is provided to area 122 of space 120 for fire suppression. In other embodiments, one or more aerating devices are provided along piping system 110 to aerate the foam. In some embodiments, sprinkler 118 are configured to aerate the foam/the fire suppressant agent.

### Aspirating Fittings

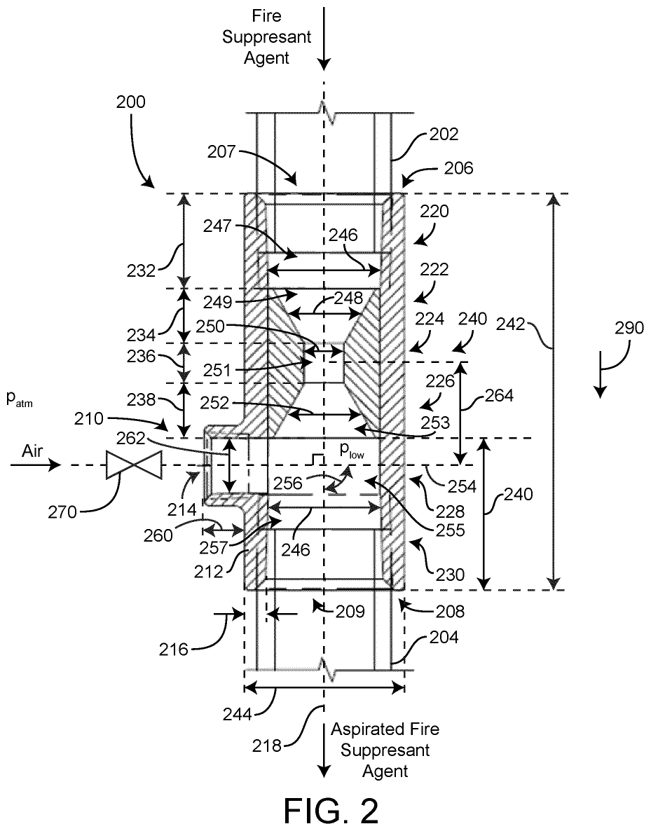

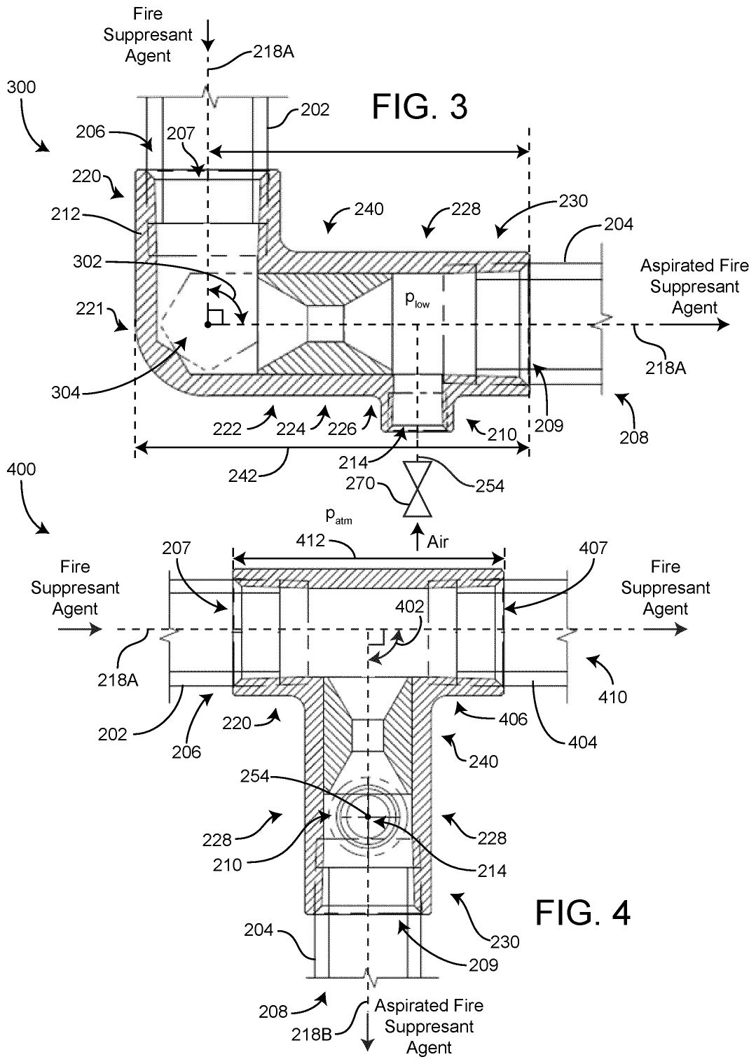

Referring now to FIGS. 2-4, various examples of connectors, fittings, etc., which can aspirate (e.g., mix air with) the fire suppressant agent (e.g., a foam) are shown, according to various exemplary embodiments. FIG. 2 shows nipple connector 200 which is configured to aspirate/aerate/expand fire suppressant agent flowing therewithin, according to an exemplary embodiment. FIG. 3 shows elbow connector 300 configured to aspirate fire suppressant agent flowing therewithin, according to another exemplary embodiment. FIG. 4 shows T-connector 400 configured to aspirate fire suppressant agent flowing therewithin, according to yet another exemplary embodiment. Any of the air aspirating fittings/connectors as shown in FIGS. 2-4 could be used in conjunction with either an aspirated sprinkler or a non-aspirated sprinkler. Aspirated sprinklers are configured to receive the fire suppressant agent via a pipe, tubing, etc., (e.g., pipe 115) or via a connector (e.g., nipple connector 200, T-connector 400, elbow connector 300, etc.) and aspirate the fire suppressant agent by introducing air into the fire suppressant agent. However, aspirating sprinklers are often bulky and expensive. Advantageously, any of the connectors shown in FIGS. 2-4 (e.g., nipple connector 200, elbow connector 300, T-connector 400) can be used in piping system 110. Piping systems often require various connectors to provide the fire suppressant agent to sprinklers 118 or to connect sprinklers 118 to the piping system. The connectors shown in FIGS. 2-4 can be used in piping system 110 to reduce the need for aspirating sprinklers. In this way, non-aspirating sprinklers could be used with a piping system 110 that includes one or more of the connectors as shown in FIGS. 2-4. Advantageously, the fire suppressant agent is already aspirated before it enters sprinklers 118 and a non-aspirated sprinkler can be used. As described herein, non-aspirated sprinklers are often smaller and less expensive. Since various connectors are already required in piping system 110, it is advantageous to pre-aspirate the fire suppressant agent by using one or more aspirating connectors (e.g., nipple connector 200, elbow connector 300, T-connector 400, etc.) in piping system 110 in place of non-aspirating connectors. Nipple connector 200, elbow connector 300, and T-connector 400 are configured to interface or fluidly couple with one or more pipes (e.g., pipes 202/204). For example, pipes 202/204 may be pipes 113/115 as shown in FIG. 1 and described in greater detail above. In an exemplary embodiment, nipple connector 200, elbow connector 300, and T-connector 400 are configured to interface or fluidly couple with pipes having equal diameters. In other embodiments, nipple connector 200, elbow connector 300, and T-connector 400 are configured to fluidly couple with pipes having unequal diameters. For example, nipple connector 200 may be configured to fluidly couple with an inlet pipe having a first outer diameter and a first inner diameter, and fluidly couple with an outlet pipe having a second outer diameter and a second inner diameter, where the second outer diameter is greater than or less than the first outer diameter, and the second inner diameter is greater than or less than the first inner diameter.

### Aspirated Nipple Connector

Referring now to FIG. 2, nipple connector 200 is shown in greater detail. Nipple connector 200 is configured to receive a fire suppressant agent at an inlet end 206 and output aerated (e.g., aspirated) fire suppressant agent at an outlet end 208, according to an exemplary embodiment. Nipple connector 200 includes an inlet, port, aperture, fitting, etc., shown as air inlet 210 and is configured to receive air via an aperture, a hole, a bore, a connector, a window, etc., shown as air inlet aperture 214.

Nipple connector 200 includes body 212 having a wall thickness 216, according to an exemplary embodiment. Body 212 defines an inner volume therewithin configured to define a fluid flow path between inlet end 206 and outlet end 208. The fire suppressant agent enters the inner volume of body 212 of nipple connector 200 via inlet aperture 207 at inlet end 206. The fire suppressant agent passes through inner volume of body 212 of nipple connector 200 and is aspirated/aerated. The fire suppressant agent exits the inner volume of body 212 via outlet aperture 209 at outlet end 208. In an exemplary embodiment, body 212 has a uniform wall thickness 216. In other embodiments, body 212 has a variable wall thickness 216 (e.g., wall thickness 216 varies at different portions of body 212).

A centerline, axis, guideline, etc., shown as central axis 218 extends through the center of body 212. Body 212 may have an overall circular outer cross-sectional shape, a hexagonal outer cross-sectional shape, a square outer cross-sectional shape, etc. As shown in FIG. 2, body 212 can have a first coupling portion 220, a converging portion 222, a restricted portion 224, a diverging portion 226, a mixing portion 228, and a second coupling portion 230, according to an exemplary embodiment. In some embodiments, nipple connector 200 does not include diverging portion 226 (e.g., diverging portion 226 is optional). First coupling portion 220, converging portion 222, restricted portion 224, diverging portion 226, mixing portion 228, and second coupling portion 230 are all disposed along central axis 218. First coupling portion 220, converging portion 222, restricted portion 224, diverging portion 226, mixing portion 228, and second coupling portion 230 are all coaxial with each other and central axis 218 extends through a center of portions 220, 222, 224, 226, 228, and 230 according to the embodiment shown in FIG. 2. In an exemplary embodiment, central axis 218 is a longitudinal axis extending through body 212 and each of portions 220, 222, 224, 226, 228, and 230.

First coupling portion 220 has longitudinal length 232, converging portion 222 has longitudinal length 234, restricted portion 224 has longitudinal length 236, diverging portion 226 has longitudinal length 238, and mixing portion 228 and second coupling portion 230 have longitudinal length 241. Each of longitudinal lengths 232-240 of portions 220, 222, 224, 226, 228, and 230 sum to equal an overall longitudinal length 242 of body 212. In an exemplary embodiment, body 212 has outer width 244. Each of portions 220, 222, 224, 226, 228, and 230 can have an outer width substantially equal to outer width 244 (or greater than, or less than). Body 212 may have a circular cross-sectional shape (i.e., outer width 244 is a diameter), a square cross-sectional shape, a hexagonal cross-sectional shape, an elliptical cross-sectional shape, etc., or any other cross-sectional shape. Body 212 may have a uniform cross sectional shape along substantially the entirety of overall longitudinal length 242 or may have a changing cross sectional shape along one or more portions of overall longitudinal length 242. For example, body 212 may have a circular cross-sectional shape along one portion, a square cross-sectional shape along another portion, and a cross-sectional shape along yet another portion.

The inner widths and therefore the inner volumes of each of portions 220, 222, 224, 226, 228, and 230 may vary. First coupling portion 220 has inner volume 247, converging portion 222 has inner volume 249, restricted portion 224 has inner volume 251, diverging portion 226 has inner volume 253, mixing portion 228 has inner volume 255, and second coupling portion 230 has inner volume 257. Inner volumes 247, 249, 251, 253, and 255/257 are defined by inner widths 246, 248, 250, 252, and 246, respectively. If inner volumes 247, 249, 251, 253, and 255/257 have a circular cross-sectional shape, inner widths 246, 248, 250, 252, and 246 are diameters. Inner volumes 247, 249, 251, 253, and 255/257 can have a circular cross-sectional shape, a square cross-sectional shape, a hexagonal cross-sectional shape, an elliptical cross-sectional shape, etc., or any other cross-sectional shape. In some embodiments, one or more of inner volumes 247, 249, 251, 253, and 255/257 have a first cross-sectional shape (e.g., a circular cross-sectional shape), and one or more of volumes 247, 249, 251, 253, and 255/257 have a second cross-sectional shape (e.g., an elliptical cross-sectional shape, a square cross-sectional shape, a rectangular cross-sectional shape, etc.) Inner volumes 247, 249, 251, 253, 255, and 257 provide a fluid flow path between inlet end 206 and outlet end 208. For example, inner volumes 247, 249, 251, 253, 255, and 257 may fluidly connect inlet aperture 207 and outlet aperture 209 such that fluid can flow into nipple connector 200 via inlet aperture 207 and exit nipple connector 200 via outlet aperture 209.

In an exemplary embodiment, first coupling portion 220 has inner width 246, converging portion has inner width 248, restricted portion 224 has inner width 250, and diverging portion 226 has inner width 252. As shown in FIG. 2, inner width 248 and inner width 252 of converging portion 222 and diverging portion 226, respectively, vary with respect to longitudinal position along central axis 218. At an upper most longitudinal position (e.g., upstream) of first coupling portion 220, width 248 of converging portion 222 is greatest. At a lowest longitudinal position (e.g., downstream) of first coupling portion 220, width 248 of converging portion 222 is smallest. Width 248 of converging portion 222 decreases along direction 290 of central axis 218. Width 248 of converging portion 222 is substantially equal to inner width 246 of first coupling portion 220 at the upper most longitudinal position of converging portion 222.

In other embodiments, width 348 of converging portion 222 is greater than or less than inner width 246 of first coupling portion 220 such that a shelf, a step, a shoulder, etc., is formed therebetween. Width 248 of converging portion 222 is substantially equal to or greater than inner width 250 of restricted portion 224 at the lowest longitudinal position of converging portion 222 along central axis 218. In this way, width 248 may equal width 246 (or be greater than width 246) at the transition between first coupling portion 220 and converging portion 222. Likewise, width 248 of converging portion 222 is substantially equal to or greater than width 250 of restricted portion 224 at the transition between converging portion 222 and restricted portion 224, according to some embodiments. For example, if width 248 of converging portion 222 is greater than width 250 of restricted portion 224 at the transition between converging portion 222 and restricted portion 224, a shoulder, step, shelf, etc., is formed therebetween. Width 248 may decrease linearly from the transition between first coupling portion 220 and converging portion 222 to the transition between converging portion 222 and restricted portion 224 along central axis 218. Specifically, width 248 may decrease linearly along longitudinal length 234 of converging portion 222. In other embodiments, width 248 decreases non-linearly from the transition between first coupling portion 220 and converging portion 222 to the transition between converging portion 222 and restricted portion 224 along central axis 218. Specifically, width 248 may decrease non-linearly (or even increase along certain portions) of longitudinal length 234 of converging portion 222.

Restricted portion 224 has a constant width 250 along substantially an entire longitudinal length 236 of restricted portion 224, according to an exemplary embodiment. In other embodiments, restricted portion 224 has a non-constant width 250 along substantially an entire longitudinal length 236 of restricted portion 224. Width 250 of restricted portion 224 is less than width 246 of first coupling portion 220. Restricted portion 224 may be a plate orifice. For example, the transition between converging portion 222 and restricted portion 224 may form a step, with restricted portion 224 being an orifice. Inner volume 251 of restricted portion 224 may have a circular cross-sectional shape, a square cross-sectional shape, a polygonal cross-sectional shape, or any other cross-sectional shape. Restricted portion 224 may be or include an orifice. If restricted portion 224 is or includes an orifice, restricted portion 224 may have a relatively small longitudinal length 236.

Diverging portion 226 has longitudinal length 238 and width 252, according to an exemplary embodiment. Diverging portion 226 may be similar to converging portion (e.g., longitudinal length 238 of diverging portion 226 may be substantially equal to longitudinal length 234 of converging portion 222), but instead of width 252 decreasing along longitudinal length 238 of diverging portion 226, width 252 of diverging portion 226 increases along longitudinal length 238 of diverging portion 226. For example, width 252 of diverging portion 226 may begin being substantially equal to width 250 of restricted portion 224 at the transition between restricted portion 224 and diverging portion 226, and increase to be substantially equal to width 248 at the transition between diverging portion 226 and mixing portion 228. Width 252 of diverging portion 226 may increase linearly along longitudinal length 238 of diverging portion 226. In other embodiments, width 252 of diverging portion 226 increases non linearly (or even decreases at some points) along longitudinal length 238 of diverging portion 226. In other embodiments, diverging portion 226 is not included. For example, restricted portion 224 may

In other embodiments, longitudinal length 236 of restricted portion 224 is negligible. For example, in some embodiments, restricted portion 224 is not included. In this embodiment, converging portion 222 transitions into diverging portion 226. Width 248 of converging portion 222 may decrease along longitudinal length 234 of converging portion 222 until it is substantially equal to width 250 at the transition between converging portion 222 and diverging portion 226.

Converging portion 222, restricted portion 224, and diverging portion 226 define a venturi 240. Venturi 240 defined by converging portion 222, restricted portion 224, and diverging portion 226 produces a lower pressure downstream of venturi 240 (e.g., at mixing portion 228) in a direction perpendicular to central axis 218 (e.g., perpendicular to the direction of flow of the fire suppressant agent). Advantageously, this lower pressure downstream of venturi and perpendicular to central axis 218 can draw air into inner volume 255 via inlet aperture 214 of air inlet 210.

Referring still to FIG. 2, air inlet 210 is configured to fluidly couple inner volume 255 of mixing portion 228 with air outside of nipple connector 200. Air may be drawn in through inlet aperture 214 of air inlet 210 due to the lower pressure downstream of venturi 240. As shown in FIG. 2, air inlet 210 has centerline 254 which extends through the center of air inlet 210. Centerline 254 is shown substantially perpendicular to central axis 218, according to an exemplary embodiment. In other embodiments, air inlet 210 is angled and therefore centerline 254 is non-perpendicular relative to central axis 218. For example, air inlet 210 may be angled such that a component of the air that enters inner volume 255 is in line with the flow of fluid through inner volume 255 of mixing portion 228 (e.g., angle 256 is greater than 90 degrees).

Air inlet 210 protrudes a distance 260 radially outwards from central axis 218. Inlet aperture 214 of air inlet 210 has width 262. Air inlet 210 may have a wall having a thickness substantially equal to wall thickness 216 of body 212. In other embodiments, air inlet 210 can have a wall thickness greater than or equal to wall thickness 216 of body 212. In some embodiments, air inlet 210 has a variable wall thickness along at least a portion of distance 260. In an exemplary embodiment, the pressure p_{low} of inner volume 255 downstream of venturi 240 is lower than atmospheric pressure pₐₜₘ such that air enters inner volume 255 via air inlet 210. The pressure p_{low} of inner volume 255 downstream of venturi 240 may be inversely proportional to a velocity v of the fire suppressant agent. The pressure p_{low} may be measured along a direction perpendicular to central axis 218 (e.g., static pressure). Venturi 240 may increase the velocity v of the fire suppressant agent, thereby decreasing p_{low} such that p_{low} is less than pₐₜₘ and the air enters inner volume 255 via air inlet 210.

Air enters inner volume 255 via air inlet 210 and mixes with the fire suppressant agent passing through inner volume 255. Inner volume 255 may be referred to as a mixing chamber. In an exemplary embodiment, the air entering inner volume 255 causes the fire suppressant agent to expand. Advantageously, aerating/aspirating the fire suppressant agent reduces the need for a sprinkler to aspirate the fire suppressant agent (e.g., a sprinkler downstream of nipple connector 200). Aspirating/aerating the fire suppressant agent can also improve the fire-suppression ability of the fire suppressant agent.

As shown in FIG. 2, air inlet 210 is positioned downstream of venturi 240. In an exemplary embodiment, air inlet 210 is positioned longitudinal distance 264 downstream from a center of venturi 240 (e.g., from a centerline extending radially outwards from central axis 218 through a center of restricted portion 224). It should be understood that longitudinal distance 264 may be greater than or less than shown. For example, air inlet 210 may be positioned closer to outlet aperture 209 and farther away from venturi 240 than shown (e.g., longitudinal distance 264 may be less than as shown) or may be positioned closer to venturi 240 and farther away from outlet aperture 209 than shown (e.g., longitudinal distance 264 may be greater than as shown). In other embodiments, air inlet 210 is positioned at a position along the longitudinal length of venturi 240. For example, air inlet 210 may be positioned at restricted portion 224 such that air inlet facilitates the entry of air into inner volume 251 of restricted portion 224 (e.g., longitudinal distance 264 is less than half of longitudinal length 236).

First coupling portion 220 and second coupling portion 230 are configured to interface or fluidly couple with pipes 202 and 204, respectively, according to an exemplary embodiment. For example, pipes 202 and pipes 204 may be configured to interface or fluidly couple with first coupling portion 220 and second coupling portion 230 within inner volume 247 and inner volume 257, respectively. First coupling portion 220 and/or second coupling portion 230 may include threads at an interior surface of first coupling portion 220 and/or second coupling portion 230. For example, an outer periphery (e.g., an outer diameter, an outer surface, an outer width, an outer edge, etc.) of pipe 202 and/or pipe 204 may be substantially equal to or slightly less than width 246 of first and second coupling portions 220 and 230, respectively. The outer periphery of pipe 202 and/or pipe 204 may include threads configured to interface with or fluidly couple with a threaded inner surface of first and second coupling portions 220 and 230, respectively. In other embodiments, an exterior surface of first and second coupling portions 220 and 230 include threads, and pipes 202 and 204 include threads at an inner surface of pipes 202 and 204, respectively. The threads on the exterior surface of first and second coupling portions 220 and 230 may be configured to threadingly interface or threadingly couple with the threads on the inner surface of pipes 202 and 204.

In other embodiments, first and second coupling portions 220 and 230 include a stepped inner sidewall. For example, first and second coupling portions 220 and 230 may have a first width along a first portion of the longitudinal length of first and second coupling portions 220 and 230 and a second width along a second portion of the longitudinal length of first and second coupling portions 220 and 230. In other embodiments, pipes 202 and 204 are configured to press fit, slip fit, snap fit, etc., with first and second coupling portions 220 and 230. Pipes 202 and 204 are configured to sealingly couple with first and second coupling portions 220 and 230 using any of the interfaces described hereinabove, according to some embodiments. In some embodiments, first coupling portion 220 and second coupling portion 230 are configured to interface or couple with pipes 202 and 204 via an adhesive. For example, an adhesive (e.g., a glue) may be coated along at least a portion of an outer periphery of pipes 202/204 and/or along at least a portion of an inner periphery of first coupling portion 220 and/or second coupling portion 230. The glue facilitates a sealed coupling between first coupling portion 220 and second coupling portion 230 and pipes 202/204. In some embodiments, pipes 202/204 and body 212 are plastic. The glued/adhered interface between pipes 202/204 and first coupling portion 220/second coupling portion 230 facilitates a sealed and fixed connection therebetween. Likewise, if pipes 202/204 are configured to interface or couple with an outer periphery (e.g., an outer surface, an outer edge, etc.) of first and second coupling portions 220 and 230, the adhesive can be applied along at least a portion of the outer periphery of any of coupling portions 220, 230, and/or 406, and/or along at least a portion of the inner periphery of pipes 202/204/404.

Air inlet 210 may include a check valve or a filter, shown as valve 270, according to an exemplary embodiment. In some cases, nipple connector 200 is connected to a system (e.g., piping system 110) which is pressurized until sprinklers 118 are activated. If the system is pressurized and nipple connector 200 is fluidly coupled with the system, valve 270 can be used to maintain the pressure within the system. When the system is de-pressurized and/or fire suppressant agent is allowed to flow through the system, valve 270 opens to allow air to enter the stream of fire suppressant agent passing through nipple connector 200. Valve 270 may be fluidly and sealingly coupled to air inlet 210. For example, valve 270 may be connected to air inlet 210 at air inlet aperture 214. Valve 270 may be or include a vent. In other embodiments, valve 270 is a one-way valve such that air can enter air inlet 210 but fire suppressant agent cannot exit air inlet 210. Advantageously, this prevents the fire suppressant agent from leaking through air inlet 210.

### Aspirated Elbow Connector

Referring now to FIG. 3, elbow connector 300 is shown in greater detail, according to an exemplary embodiment. Elbow connector 300 is configured to operate similarly to nipple connector 200 to aspirate/aerate fire suppressant agent which enter at inlet end 206 via inlet aperture 207. Elbow connector 300 is configured to output the aspirated/aerated fire suppressant agent (e.g., expanded foam) at outlet end 208 via outlet aperture 209.

Elbow connector 300 may share one or more components, portions, features, geometry, etc., of nipple connector 200, according to an exemplary embodiment. For example, elbow connector 300 includes first coupling portion 220, converging portion 222, restricted portion 224, diverging portion 226, mixing portion 228, and second coupling portion 230. Each of first coupling portion 220, converging portion 222, restricted portion 224, diverging portion 226, mixing portion 228, and second coupling portion 230 share the same or similar features as the corresponding portions of nipple connector 200. For example, first coupling portion 220 may have a similar inner volume with a similar inner width as first coupling portion 220 described in greater detail above with reference to FIG. 2. Likewise, second coupling portion 230 may have a similar inner volume with a similar inner width as second coupling portion 230 as described in greater detail above with reference to FIG. 2. First coupling portion 220 is configured to receive pipe 202 and sealingly (e.g., via threads, a press fit, a slip fit, etc.) couple with pipe 202. The fire suppressant agent may be provided to elbow connector 300 via pipe 202. Likewise, second coupling portion 230 is configured to receive pipe 204 and sealingly couple with pipe 204. The aerated fire suppressant agent may exit elbow connector 300 via pipe 204. Pipe 204 may provide the aerated fire suppressant agent to a sprinkler, a nozzle, a dispersion device, etc., downstream of elbow connector 300. Pipes 202 may be pipes 113 and 115 as shown in FIG. 1 described in greater detail above.

Additionally, air inlet 210 is shown longitudinally offset such that it is downstream of venturi 240, similar to nipple connector 200 as shown in FIG. 2. Air inlet 210 is configured to provide air to an inner volume (e.g., mixing chamber) of mixing portion 228 where the fire suppressant agent may be aerated/aspirated by the air. Similar to nipple connector 200, the pressure within inner volume of mixing portion 228 is at a lower pressure p_{low} than the atmospheric pressure pₐₜₘ, thereby facilitating the entry of air via air inlet 210. Similar to nipple connector 200, air inlet 210 may be fluidly connected to the inner volume of restricted portion 224 of venturi 240.

However, elbow connector 300 includes additional portions and features when compared to nipple connector 200. While nipple connector 200 may be used for pipes 202/204 which are substantially co-axial with each other, elbow connector 300 can be used for pipe 202/204 which are angled relative to each other. As shown in FIG. 3, elbow connector 300 includes elbow portion 221. Elbow portion 221 is disposed between first coupling portion 220 and converging portion 222. Elbow portion 221 is a generally angled portion with inner volume 304. Inner volume 304 is fluidly coupled with the inner volumes of adjacent first coupling portion 220 and adjacent converging portion 222, to facilitate the flow of fluid (e.g., the fire suppressant agent) from the inner volume of first coupling portion 220 and the inner volume of converging portion 222. Elbow portion 221 defines a bend, curve, turn, arc, contour, angle, corner, etc., of elbow connector 300.

As shown in FIG. 3, elbow connector 300 includes second central axis 218B and first central axis 218A, according to an exemplary embodiment. As shown in FIG. 3, second central axis 218B and first central axis 218A are substantially perpendicular (e.g., orthogonal) to each other. Angle 302 is defined between first central axis 218A and second central axis 218B. As shown in FIG. 3, angle 302 is substantially 90 degrees. In other embodiments, angle 302 is greater than or less than 90 degrees. For example, angle 302 may be 120 degrees, 45 degrees, 130 degrees, etc. The value of angle 302 may be adjusted in various embodiments to provide a connector for various applications (e.g., to connect pipes 202/204 which are at angles other than 90 degrees relative to each other).

First coupling portion 220 is substantially coaxial with first central axis 218A. In an exemplary embodiment, first central axis 218A is defined as an axis extending longitudinally through a center of first coupling portion 220. For example, first central axis 218A may be defined as an axis extending normally through a center of inlet aperture 207. Converging portion 222, restricted portion 224, diverging portion 226, mixing portion 228, and second coupling portion 230 are substantially co-axial with each other and are centered about second central axis 218B, according to an exemplary embodiment. For example, second central axis 218B may be defined as an axis extending longitudinally through converging portion 222, restricted portion 224, diverging portion 226, mixing portion 228, and second coupling portion 230.

Elbow connector 300 is similar to nipple connector 200 since it includes a single inlet (e.g., inlet aperture 207) and a single outlet (e.g., outlet aperture 209). Elbow connector 300 also includes a single air inlet 210 disposed downstream of venturi 240. However, the overall configuration of elbow connector 300 is different than nipple connector 200 since it includes elbow portion 221 which defines angle 302 between first central axis 218A and second central axis 218B. Elbow portion 221 defines a bend upstream of venturi 240. In other embodiments, elbow portion 221 is positioned downstream of venturi 240 (e.g., and also downstream of air inlet 210). For example, first coupling portion 220 may be collinear with venturi 240 and disposed upstream of venturi 240, while elbow portion 221 may define a bend, curve, turn, elbow, etc., having angle 302 downstream of venturi 240 and air inlet 210. In other embodiments, multiple inlet/outlet apertures are used, as shown in FIG. 4 and described in greater detail below.

### Aspirated T-Connector

Referring now to FIG. 4, T-connector 400 is shown in greater detail, according to an exemplary embodiment. T-connector 400 functions similarly to the nipple connector 200 and the elbow connector 300 as described in greater detail above with reference to FIGS. 2 and 3. T-connector 400 may share one or more of the same features, components, portions, etc., of nipple connector 200 and/or elbow connector 300. For example, T-connector 400 includes venturi 240 (e.g., converging portion 222, restricted portion 224, and diverging portion 226), first coupling portion 220, mixing portion 228, and second coupling portion 230. Additionally, T-connector 400 includes air inlet 210 positioned downstream of venturi 240 or positioned at restricted portion 224. It should be noted that, similar to elbow connector 300 as described in greater detail above with reference to FIG. 3, T-connector 400 includes first central axis 218A and second central axis 218B. First coupling portion 220 is centered about first central axis 218A. Venturi 240, mixing portion 228, and second coupling portion 230 are centered about second central axis 218B. First central axis 218A and second central axis 218B form angle 402 therebetween. As shown in FIG. 4, angle 402 is ninety degrees. In other embodiments, angle 402 is greater than or less than ninety degrees.

T-connector 400 includes inlet end 206 and outlet end 208. Inlet end 206 includes inlet aperture 207 and outlet end 208 includes outlet aperture 209. However, T-connector 400 also includes third coupling portion 406 and second outlet end 410. Third coupling portion 406 may be similar and symmetric to first coupling portion 220. For example, third coupling portion 406 may have an inner volume fluidly connected with inner volume 247 of first coupling portion 220. Inlet end 206 and second outlet end 410 are coaxial/collinear with each other such that both inlet end 206 and second outlet end 410 are positioned centrally about first central axis 218A. First central axis 218A may be defined as a central axis of first coupling portion 220 and third coupling portion 406. For example, first central axis 218A may be defined as an axis extending normally through a center of inlet aperture 207 and second outlet aperture 407. As shown in FIG. 4, T-connector 400 has an overall T-shape. First coupling portion 220 and third coupling portion 406 may define flanges of the overall T-shape. Venturi 240, mixing portion 228, and second coupling portion 230 may define the web portion of the overall T-shape. Third coupling portion 406 can be configured to couple with pipe 404 similar to the interface or coupling between first and second coupling portions 220/230 and pipes 202/204.

The web portion of the overall T-shape as defined by venturi 240, mixing portion 228, and second coupling portion 230 may be disposed at a central longitudinal position along first central axis 218A. For example, the web portion may be centrally located along the flanges (e.g., first coupling portion 220 and third coupling portion 406). As shown in FIG. 4, first coupling portion 220 and third coupling portion 406 are integrally formed with each other (as well as being integrally formed with venturi 240) and having an overall longitudinal length 412. The web portion of the overall T-shape of T-connector 400 may be positioned at a central location along longitudinal length 412. For example, second central axis 218B may be positioned at a center of longitudinal length 412.

Inlet aperture 207 of inlet end 206 is configured to receive fire suppressant agent via pipe 202. Pipe 202 may be a first portion of pipe 115 as shown in FIG. 1 and described in greater detail above. The fire suppressant agent may pass through the inner volume as defined by first coupling portion 220 and third coupling portion 406. The fire suppressant agent may exit second outlet end 410 via second outlet aperture 407. Second outlet aperture 407 may be coupled (e.g., sealingly, threadingly, etc.) with pipe 404. Pipe 404 may be a second portion of pipe 115 as shown in FIG. 1 and described in greater detail above. Some of the fire suppressant agent may branch off from the flow path defined by the inner volume between inlet aperture 207 and second outlet aperture 407 and pass through the web portion of T-connector 400. For example, the fire suppressant agent may branch off and pass through venturi 240. Air may enter via air inlet 210 and mix with the fire suppressant agent within the mixing chamber of mixing portion 228. Aspirated fire suppressant agent may then exit outlet end 208 via outlet aperture 209.

T-connector 400 may be used for multiple sprinklers 118 disposed along a pipe. For example, multiple T-connectors 400 may be positioned along the pipe (e.g., pipe 115) and supply sprinklers 118 with the aspirated fire suppressant agent at outlet end 208 via outlet aperture 209. Each of the T-connectors 400 may be fluidly connected with pipe 115 via inlet aperture 207 and second outlet aperture 407. T-connectors 400 may be fluidly connected along a fluid flow path of pipe 115 via inlet aperture 207 and second outlet aperture 407. Each T-connector 400 may branch a portion of the fire suppressant agent through the web (e.g., through venturi 240) of the T-connector 400, where the fire suppressant agent is aspirated (e.g., via inlet aperture 207 and the mixing chamber of mixing portion 228) and then provided to a sprinkler 118 fluidly coupled with outlet aperture 209. In this way, multiple sprinklers 118 may be connected to pipe 115 and the fire suppressant agent may be aspirated before it enters each of sprinklers 118.

Referring now to FIGS. 7-8, various configurations of T-connector 400 are shown. As shown in FIG. 7, centerline 254 which extends through the center of air inlet 210 is substantially collinear with central axis 218A. Air may enter the mixing chamber of T-connector 400 via air inlet 210 (e.g., via air inlet aperture 214). In other embodiments, however, air inlet 210 is angled as shown in FIG. 8. As shown in FIG. 8, angle 1102 is formed between centerline 254 and central axis 218A. In the embodiment shown in FIG. 8, angle 1102 is substantially ninety degrees. However, in other embodiments, angle 1102 is greater than or less than ninety degrees. In this way, air may be introduced to the fire suppressant agent via air inlet 210 at a variety of angles. However, the air may still be introduced such that it is substantially perpendicular to the flow path of the fire suppressant agent. The embodiment shown in FIG. 7 corresponds to the embodiment of T-connector 400 as shown in FIG. 4, while the embodiment shown in FIG. 8 corresponds to the embodiment of T-connector 400 as shown in FIG. 11 (below).

### Check Valve

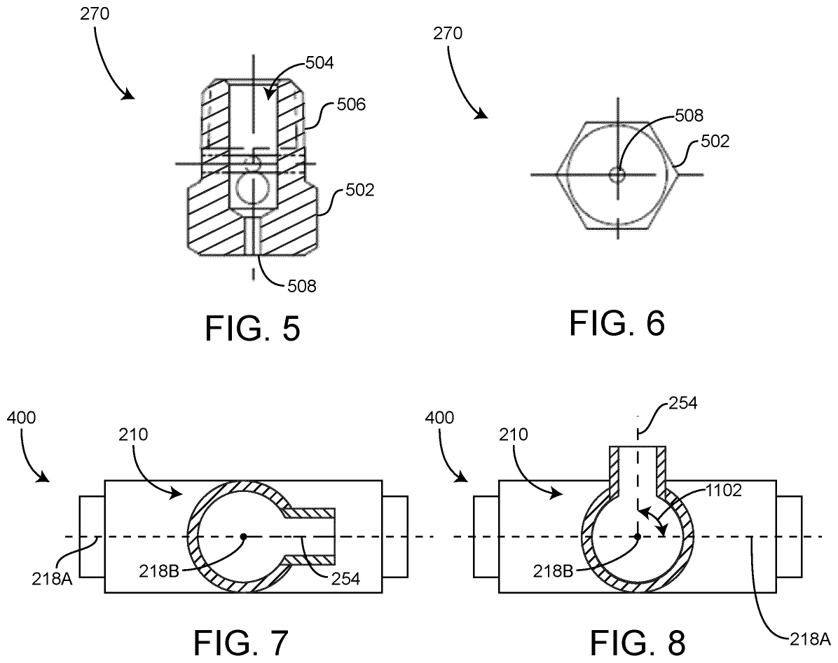

Referring now to FIGS. 5 and 6, valve 270 is shown in greater detail, according to an exemplary embodiment. Valve 270 includes body 502, and an inner volume 504. Inner volume 504 is configured to facilitate the flow of air therewithin. Inner volume 504 may extend an entire length of valve 270, facilitate flow between both ends of valve 270w. Valve 270 may be a ball valve, a poppet valve, a piston valve, a top hinged valve, a tilting disk valve, a diaphragm valve, a stop check valve, etc., of any other type of one-way valve. Valve 270 may include inlet aperture 508 configured to facilitate the entry of air to inner volume 504. Valve 270 may include threads 506 configured to threadingly and sealingly interface or couple with an interior surface of air inlet 210. Valve 270 is configured to facilitate the entry of air into the mixing chamber or an inner volume of any of the aspirated connectors as described in greater detail herein, and restrict the egress of fire suppressant agent/air from the inner volume (e.g., the mixing chamber) of nipple connector 200, elbow connector 300, and T-connector 400. Valve 270 may have a hexagonal outer perimeter configured to facilitate attachment of valve 270 (e.g., a user may put a wrench on valve 270 and tighten valve 270 to provide the threaded and sealed interface or coupling). In other embodiments, valve 270 has a square outer perimeter, a circular outer perimeter, etc., or any other shape. Valve 270 can be configured to sealingly interface with or couple with air inlet 210 via an adhesive (e.g., an epoxy, a resin, a glue, etc.). The glued/adhered interface or coupling between valve 270 and air inlet 210 can be used if valve 270 and/or body 212 are made from a plastic.

### Flow Paths

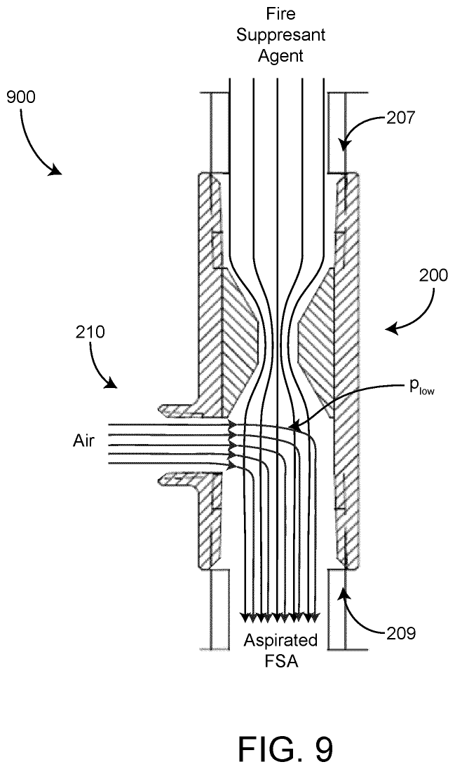

Referring now to FIGS. 9-11, diagrams 900, 1000, and 1100 illustrate the flow path of the fire suppressant agent and the air introduced via air inlet 210. The flow paths of the fire suppressant agent and the air introduced to each of nipple connector 200, elbow connector 300, and T-connector 400 as shown in FIGS. 9-11 are formed by the inner volume of the various portions.

Referring now to FIG. 9, diagram 900 illustrates the flow path of the fire suppressant agent and the air through nipple connector 200, according to an exemplary embodiment. The fire suppressant agent (e.g., the foam) enters nipple connector 200 via inlet aperture 207. As shown in FIG. 9, the fire suppressant agent enters venturi 240 and is constricted. The fire suppressant agent then exits venturi 240 and is at a lower pressure than before it entered venturi 240. Air inlet 210 is configured to provide air to the fire suppressant agent at the low pressure region. Air enters nipple connector 200 via air inlet 210 and mixes with the fire suppressant agent at the low pressure region downstream of venturi 240. The aspirated fire suppressant agent then exits nipple connector 200 via outlet aperture 209.

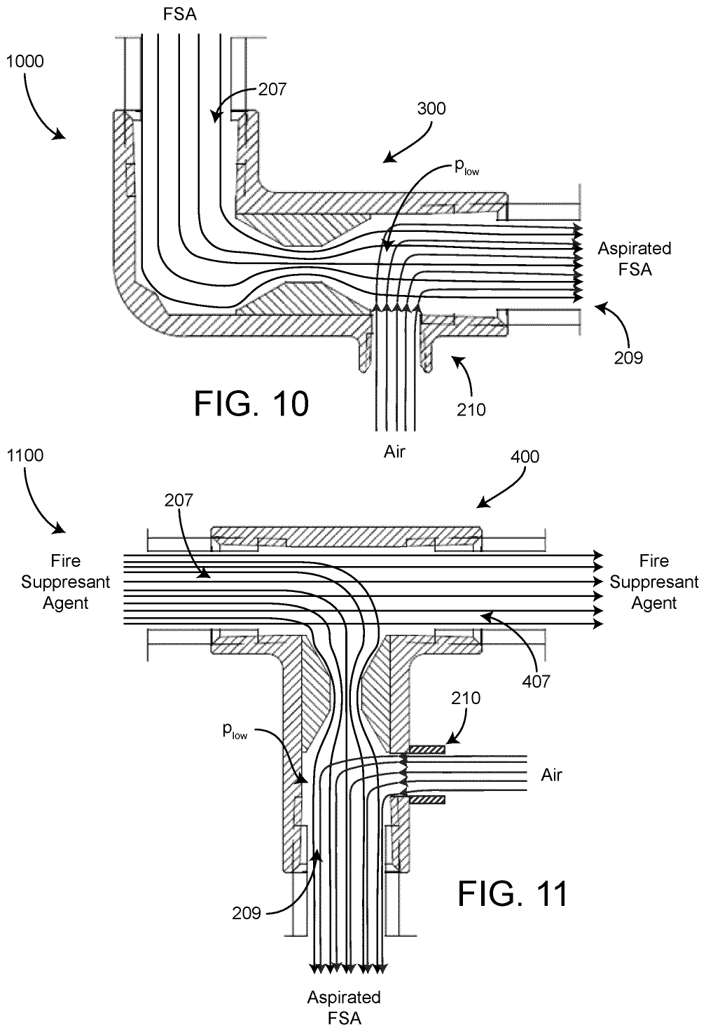

Referring now to FIG. 10, diagram 1000 illustrates the flow path of the fire suppressant agent through elbow connector 300, according to an exemplary embodiment. The fire suppressant agent (FSA) enters elbow connector 300 via inlet aperture 207. The fire suppressant agent then flows around the bend defined by elbow portion 221 and enters venturi 240. The fire suppressant agent is constricted as it flows through venturi 240. When the fire suppressant agent exits venturi 240, a low pressure region is produced. Air inlet 210 is configured to provide air to the fire suppressant agent at the low pressure region downstream of venturi 240. The air mixes with the fire suppressant agent exiting venturi 240 and the aspirated fire suppressant agent exits elbow connector 300 at outlet aperture 209.

Referring now to FIG. 11, diagram 1100 illustrates the flow path of the fire suppressant agent through T-connector 400, according to an exemplary embodiment. The fire suppressant agent enters T-connector 400 via inlet aperture 207. Some of the fire suppressant agent flows through the upper, flange portion of T-connector 400 and exits via second outlet aperture 407. This fire suppressant agent may be provided to any other sprinkler 118 (e.g., an aspirated sprinkler) or any other aspirated connector (e.g., nipple connector 200, elbow connector 300, T-connector 400, etc.). Some of the fire suppressant agent branches off from the flow path defined between inlet aperture 207 and second outlet aperture 407 and enters venturi 240. The fire suppressant agent flows through venturi 240 and a low pressure region is produced downstream of venturi 240. Air inlet 210 is positioned at the low pressure region and is configured to provide air to the low pressure region downstream of venturi 240. Air inlet 210 may be configured as shown in FIG. 7, or as shown in FIG. 8. The air enters the low pressure region (e.g., the mixing chamber) and mixes with the fire suppressant agent. The aspirated fire suppressant agent may then exit T-connector 400 via outlet aperture 209. The aspirated fire suppressant agent may be provided to a sprinkler (e.g., a non-aspirated sprinkler).

The various aspirated connectors (e.g., nipple connector 200, elbow connector 300, T-connector 400) as shown in the FIGURES and described in greater detail above provide several advantages over other connectors which are non-aspirated. Firstly, many fire suppressant agents require some form of aspiration to expand the foam (e.g., the fire suppressant agent). The expansion/aspiration/aeration of the fire suppressant agent may improve the sprinklers ability to distribute the fire suppressant agent, as well as the fire suppressing properties of the fire suppressant agent. Secondly, the aspirated connectors described herein remove the need for aspirated sprinklers. Aspirated sprinklers are often expensive as well as large and bulky. The fire suppressant agent can be aspirated/aerated before it is provided to the sprinklers using any of the aspirated connectors described in greater detail above. Advantageously, this removes the need for aspirated sprinklers and enables the fire suppressant agent to be used in non-aspirated sprinklers. Non-aspirated sprinklers are often less expensive and smaller. Therefore, using the aspirated connectors enables the use of less expensive and smaller sprinklers which can reduce costs associated with purchasing, sizing, and installing fire suppression systems. Another advantage is that many fire suppression systems already use connectors in the plumbing/piping systems which provide the fire suppressant agent to the sprinklers. The various nipple, elbow, and T-connectors of a fire suppression piping system may simply be replaced with nipple connector 200, elbow connector 300, and T-connector 400. Advantageously, this reduces the need to add additional components to a system in order to aspirate the fire suppressant agent.

### Additional Embodiments

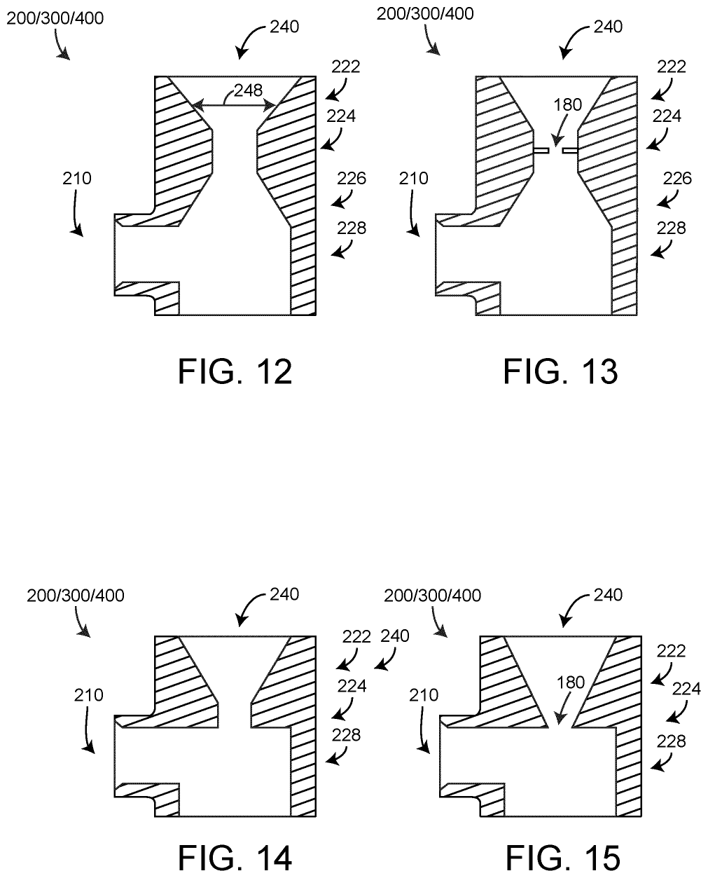

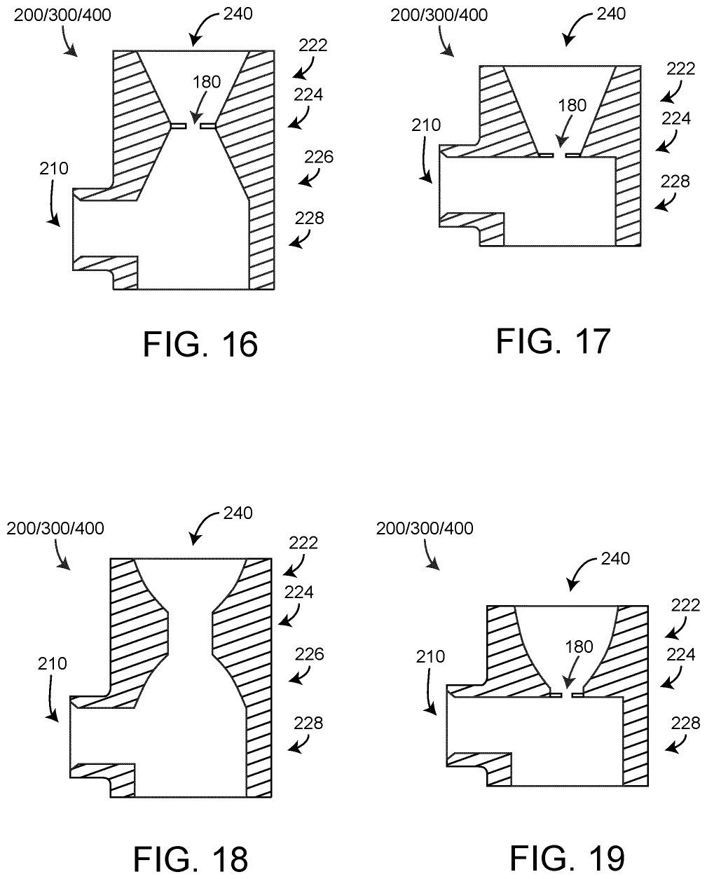

Referring now to FIGS. 12-19, various exemplary embodiments of venturi 240 are shown. The embodiments of venturi 240 shown in FIGS. 12-19 should not be regarded as limiting. Additionally, any component or feature of venturi 240 as shown in FIGS. 12-19 may be incorporated into any other embodiment of venturi 240 as described in the present disclosure. Any of the embodiments of venturi 240 as shown in FIGS. 12-19 may be incorporated into any of nipple connector 200, elbow connector 300, and T-connector 400. FIG. 12 shows venturi 240 as shown in FIGS. 2-4 and 9-11. As shown in FIGS. 13-19, diverging portion 226 may be optional (as shown in FIGS. 14, 15, 17, and 19), such that restricted portion 224 is directly fluidly coupled to the inner volume of mixing portion 228. Restricted portion 224 may include an orifice 180 (as shown in FIGS. 13, 16, 17, and 19) configured to facilitate producing a low pressure within the inner volume of mixing portion 228. In some embodiments, restricted portion 224 has a negligible longitudinal length (as shown in FIGS. 15 and 17). In some embodiment, restricted portion 224 defines orifice 180 (as shown in FIG. 15). Additionally, converging portion 222 may have a linearly decreasing width 248 (as shown in FIGS. 12-17), or may have a non-linearly decreasing width 248 (as shown in FIGS. 18 and 19). Likewise, if diverging portion 226 is included, diverging portion 226 may have a linearly increasing width (as shown in FIGS. 12, 13, and 16) or may have a non-linearly increasing width (as shown in FIG. 18). The embodiments of FIGS. 12-19 show various options that can be used to produce a low pressure at the mixing chamber to draw air via air inlet 210 to aspirate the fire suppressant agent (e.g., the non-fluorinated foam).

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

Additionally, any element disclosed in one embodiment may be incorporated or utilized with any other embodiment disclosed herein. For example, the configuration and orientation of the air inlet 210 of the exemplary embodiment described in at least paragraph [0063] may be incorporated in the nipple connector 200 of the exemplary embodiment described in at least paragraph [0052]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A connector for a fire suppression system, the connector comprising:
a body;
an inlet comprising an inlet aperture configured to receive a fire suppressant agent;
an outlet comprising an outlet aperture configured to output aspirated fire suppressant agent;
an inner volume of the body defining a fluid flow path between the inlet and the outlet;
a venturi portion positioned along the fluid flow path of the inner volume and configured to produce a low pressure region within the inner volume of the body; and
an air inlet configured to provide air to the low pressure region.

2. The connector of claim 1, wherein the connector is a nipple connector, an elbow connector, or a T-connector.

3. The connector of claim 1, wherein the inlet aperture is configured to fluidly couple with a first pipe configured to provide the fire suppressant agent to the inlet and the outlet aperture is configured to fluidly couple with a second pipe to discharge aspirated fire suppressant agent.

4. The connector of claim 1, wherein the connector is configured to aerate, aspirate, or expand the fire suppressant agent.

5. The connector of claim 1, wherein the air inlet is configured to provide the air to the low pressure region at a position downstream of the venturi portion.

6. The connector of claim 1, further comprising a one-way valve coupled to the air inlet and configured to allow a flow of air into the inner volume of the connector and restrict a flow of the fire suppressant agent out of the inner volume of the connector.

7. The connector of claim 1, wherein the air inlet is configured to provide air into the inner volume in a direction substantially perpendicular to a flow of the fire suppressant agent.

8. The connector of claim 1, wherein the fire suppressant agent is or includes non-fluorinated foam.

9. The connector of claim 1, wherein the venturi portion comprises a converging portion and an orifice positioned downstream of the converging portion.

10. A fire suppression system configured to provide a fire suppressant agent to an area for fire suppression, the system comprising:
a delivery system; and
a piping system fluidly coupled to the delivery system, wherein the delivery system is configured to move the fire suppressant agent through the piping system;
wherein the piping system comprises a connector configured to aspirate the fire suppressant agent, the connector comprising:
a body;
an inlet comprising an inlet aperture configured to receive the fire suppressant agent;
an outlet comprising an outlet aperture configured to output aspirated fire suppressant agent;
an inner volume of the body defining a fluid flow path between the inlet and the outlet;
a venturi portion positioned along the fluid flow path of the inner volume and configured to produce a low pressure region within the inner volume of the body; and
an air inlet configured to provide air to the low pressure region.

11. The system of claim 10, wherein the fire suppressant agent is a foam fire suppressant agent.

12. The system of claim 10, wherein the connector is a nipple connector, an elbow connector, or a T-connector.

13. The system of claim 10, wherein the inlet aperture is configured to fluidly couple with a first pipe of the piping system to provide the fire suppressant agent to the inlet and the outlet aperture is configured to fluidly couple with a second pipe of the piping system to discharge aspirated fire suppressant agent.

14. The system of claim 10, wherein the connector is configured to aerate, aspirate, or expand the fire suppressant agent.

15. The system of claim 10, wherein the air inlet is configured to provide the air to the low pressure region at a position downstream of the venturi.

16. The system of claim 10, further comprising a one-way valve coupled to the air inlet and configured to allow flow of air into the inner volume of the connector and restrict flow of the fire suppressant agent out of the inner volume of the connector.

17. The system of claim 10, wherein the air inlet is configured to provide air into the inner volume in a direction substantially perpendicular to a flow of the fire suppressant agent.

18. A method for suppressing a fire, the method comprising:
providing a fire suppression system comprising a tank configured to store a fire suppressant agent, a piping system fluidly coupled with the tank, a connector, and a discharge device fluidly coupled to the piping system downstream of the connector;
driving the fire suppressant agent through the piping system and the connector to the discharge device;
wherein the connector comprises an inner passageway configured to receive the fire suppressant agent at a first end, draw air into the fire suppressant agent at a low pressure region to aspirate the fire suppressant agent, and discharge the fire suppressant agent at a second end.

19. The method of claim 18, wherein the connector is any of a nipple connector, an elbow connector, or a T-connector and is configured to aspirate the fire suppressant agent before the fire suppressant agent is provided through the piping system to the discharge device.

20. The method of claim 18, wherein the connector comprises:
a venturi portion, the venturi portion configured to produce the low pressure region; and
an air inlet fluidly coupled with atmospheric air and the low pressure region, wherein a flow of the fire suppressant agent through the connector draws air into the connector through the air inlet to aspirate the fire suppressant agent.
